(19) United States
(12) Patent Application Publication
(10) Pub. No.: US 2026/0253000 A1
(43) Pub. Date: Aug. 27, 2026

(54) MANAGING ARTIFICIAL INTELLIGENCE (AI) WORKFLOWS

(71) Applicant: Palantir Technologies Inc., Denver, CO (US)

(72) Inventors: Arjun Banerjee, London (GB); Megha Arora, London (GB); Abhinav Swaminathan, Brooklyn, NY (US); Lewis David Woolfson, London (GB); Tavish Gobindram, London (GB)

(21) Appl. No.: 19/537,261

(22) Filed: Feb. 11, 2026

Related U.S. Application Data
(60) Provisional application No. 63/764,146, filed on Feb. 27, 2025.

(51) Int. Cl. G06Q 10/0633; G06F 3/0481; G06F 9/451; G06N 20/00

(52) U.S. Cl. CPC G06Q 10/0633; G06F 3/0481; G06F 9/451; G06N 20/00

(57) ABSTRACT

Various example embodiments relate generally to managing computer workflows, for example artificial intelligence (AI) workflows. For example, a computer-implemented method may comprise obtaining workflow data representing a workflow of a software product, the workflow data indicating at least one task, providing at least a first model configuration indicating at least a first model for performing the at least one task based on at least one hyperparameter, and evaluating, at each of a plurality of time instances, performance of the at least one task using the at least first model configuration to provide respective evaluation results. The respective evaluation results may be logged in a data set. The method may further comprise providing, based on the data set, a developer-side user interface and an operations-side user interface.

### CROSS REFERENCE TO RELATED APPLICATIONS

This application claims priority to U.S. Provisional Application No. 63/764,146, filed Feb. 27, 2025, incorporated by reference herein for all purposes.

### TECHNICAL FIELD

Various example embodiments relate generally to managing computer workflows, for example artificial intelligence (AI) workflows.

### BACKGROUND

An application may comprise a workflow, wherein the workflow comprises at least one task performed by a computer-based model. In this context, the workflow might be termed an artificial intelligence (AI) workflow. For example, a generative AI workflow may involve use of one or more generative computer-based models for producing, for example, text, images, videos or other forms of data based on input data. Large language models (LLMs) are one example of generative computer-based models. The non-deterministic nature of such models, where the same input may produce different outputs at different times, may be problematic, for example when the output affects critical downstream processes or operations.

### SUMMARY

According to some aspects, there is provided the subject matter of the independent claims. Some further aspects are defined in the dependent claims. The embodiments that do not fall under the scope of the claims are to be interpreted as examples useful for understanding the disclosure.

According to a first aspect, there is provided a method, wherein the method is performed using one or more processors, the method comprising: obtaining workflow data representing a workflow of a software product, the workflow data indicating at least one task of the software product; providing at least a first model configuration indicating at least a first model for performing the at least one task based on at least one hyperparameter or set of hyperparameters; evaluating, at each of a plurality of time instances, performance of the at least one task using the at least first model configuration to provide respective evaluation results; logging the respective evaluation results and their association with the at least first model configuration in a data set associated with the at least one task; and providing, based on the data set, at least: a developer-side user interface for displaying at least first display data indicating the at least one task, at least some of the respective evaluation results and their association with the at least first model configuration, and an operations-side user interface for displaying at least second output data indicating at least some of the first display data, wherein the operations-side user interface is accessible by at least one user of the software product.

In some examples, the method further comprises receiving feedback data indicative of operational performance of the at least one task of the software product using the at least first model configuration, wherein the feedback data is stored in the data set in association with the at least first model configuration for the task and is accessible via the developer-side user interface and the operations-side user interface. In some examples, the method further comprises enabling, via input to the operations-side user interface, association of at least feedback template with the at least one task of the software product, wherein the association integrates the at least one feedback template as part of the software product and the feedback data is received via the at least one feedback template. In some examples, the at least one feedback template provides at least one form for requesting feedback data from a user of the software product.

In some examples, the method further comprises modifying at least part of the at least first model configuration to provide at least a second model configuration and re-performing the evaluating.

In some examples, the modifying is performed based, at least in part, on the feedback data.

In some examples, the evaluating comprises evaluating, at one or more first time instances, performance of the at least one task using the at least first model configuration and, at one or more second time instances, performance of the at least one task using at least the second model configuration, wherein the respective evaluation results are displayed to the developer-side user interface with respect to a timeline. In some examples, the at least second model configuration comprises at least one of a different version of the first model or a different model to the first model. In some examples, the second model is selected, via the developer-side user interface, from a list of selectable models for replacing the first model. In some examples, the at least second model configuration comprises at least one modified hyperparameter or set of hyperparameters. In some examples, the at least one modified hyperparameter or set of hyperparameters is or are received via the developer-side user interface. In some examples, the at least one modified hyperparameter or set of hyperparameters comprises at least one of a prompt, a temperature, or other inference hyperparameter.

In some examples, the evaluating comprises running, at each of the plurality of time instances, at least one evaluator program to evaluate performance of the at least one task with respect to a, or a respective, metric. In some examples, the at least one evaluator program is selected based on a category assigned to the at least one task via the developer-side user interface.

In some examples, the at least one evaluator program evaluates performance with respect to at least one of, but not limited to: prompt drift, correctness of output, conciseness of output, readability of output, semantic equality of output or output structure adherence. The above list is not exhaustive and performance may be evaluated with respect to any form of evaluator program.

In some examples, the at least first model configuration is activated in the software product for performing the at least one task, the method further comprising: receiving monitoring data indicative of a consecutive runs of the at least first model configuration; logging the monitoring data in the data set in association with the at least first model configuration; and outputting, to at least the developer-side user interface, an indication of at least some of the monitoring data. In some examples, the monitoring data includes at least one of time of a most-recent run, total number of runs, average token usage for total number of runs, or average latency for total number of runs.

In some examples, the method further comprises receiving, via the developer-side user interface, an activation input for activating a non-activated model configuration in the software product; and activating the non-activated model in the software product.

In some examples, the data set comprises a version-controlled object model associated with the workflow of the software product.

In some examples, the at least first model is a large language model (LLM).

According to a second aspect, there is provided a system comprising: at least one processor; and at least one memory storing instructions that, when executed by the at least one processor, cause the system to: obtain workflow data representing a workflow of a software product, the workflow data indicating at least one task of the software product; provide at least a first model configuration indicating at least a first model for performing the at least one task based on at least one hyperparameter or set of hyperparameters; evaluate, at each of a plurality of time instances, performance of the at least one task using the at least first model configuration to provide respective evaluation results; log the respective evaluation results and their association with the at least first model configuration in a data set associated with the at least one task; and provide, based on the data set, at least: a developer-side user interface for displaying at least first display data indicating the at least one task, at least some of the respective evaluation results and their association with the at least first model configuration, and an operations-side user interface for displaying at least second output data indicating at least some of the first display data, wherein the operations-side user interface is accessible by at least one user of the software product.

In some examples, the second aspect may comprise any feature described above in relation to the first aspect.

According to a third aspect, there is provided a computer program product comprising program instructions which, when the program instructions are executed by a first apparatus, cause the first apparatus to carry out a method comprising: obtaining workflow data representing a workflow of a software product, the workflow data indicating at least one task of the software product; providing at least a first model configuration indicating at least a first model for performing the at least one task based on at least one hyperparameter or set of hyperparameters; evaluating, at each of a plurality of time instances, performance of the at least one task using the at least first model configuration to provide respective evaluation results; logging the respective evaluation results and their association with the at least first model configuration in a data set associated with the at least one task; and providing, based on the data set, at least: a developer-side user interface for displaying at least first display data indicating the at least one task, at least some of the respective evaluation results and their association with the at least first model configuration, and an operations-side user interface for displaying at least second output data indicating at least some of the first display data, wherein the operations-side user interface is accessible by at least one user of the software product.

In some examples, the third aspect may comprise any feature described above in relation to the first aspect.

According to a fourth aspect, there is provided a computer program product embodied on a non-transitory distribution medium readable by a computer and comprising program instructions which, when the program instructions are executed by a first apparatus, cause the first apparatus to carry out a method comprising: obtaining workflow data representing a workflow of a software product, the workflow data indicating at least one task of the software product; providing at least a first model configuration indicating at least a first model for performing the at least one task based on at least one hyperparameter or set of hyperparameters; evaluating, at each of a plurality of time instances, performance of the at least one task using the at least first model configuration to provide respective evaluation results; logging the respective evaluation results and their association with the at least first model configuration in a data set associated with the at least one task; and providing, based on the data set, at least: a developer-side user interface for displaying at least first display data indicating the at least one task, at least some of the respective evaluation results and their association with the at least first model configuration, and an operations-side user interface for displaying at least second output data indicating at least some of the first display data, wherein the operations-side user interface is accessible by at least one user of the software product.

In some examples, the fourth aspect may comprise any feature described above in relation to the first aspect.

According to a fifth aspect of the present disclosure, there is provided an apparatus or system, comprising means for obtaining workflow data representing a workflow of a software product, the workflow data indicating at least one task of the software product; means for providing at least a first model configuration indicating at least a first model for performing the at least one task based on at least one hyperparameter or set of hyperparameters; means for evaluating, at each of a plurality of time instances, performance of the at least one task using the at least first model configuration to provide respective evaluation results; means for logging the respective evaluation results and their association with the at least first model configuration in a data set associated with the at least one task; and means for providing, based on the data set, at least: a developer-side user interface for displaying at least first display data indicating the at least one task, at least some of the respective evaluation results and their association with the at least first model configuration, and an operations-side user interface for displaying at least second output data indicating at least some of the first display data, wherein the operations-side user interface is accessible by at least one user of the software product.

In some examples, the fifth aspect may comprise any feature described above in relation to the first aspect.

### BRIEF DESCRIPTION OF THE DRAWINGS

In the following, example embodiments will be described in greater detail with reference to the embodiments and the accompanying drawings, in which:

FIG. 1 illustrates a system in accordance with some example embodiments;

FIG. 2 illustrates an example workflow;

FIG. 3 illustrates a first page of a developer-side user interface;

FIG. 4 illustrates a second page of the developer-side user interface;

FIG. 5 illustrates an ontology according to some example embodiments;

FIG. 6 illustrates a first page of an operations-side user interface;

FIG. 7 illustrates a second page of an operations-side user interface;

FIG. 8 is a flow diagram indicating processing operations in accordance with some example embodiments; and

FIG. 9 illustrates a system.

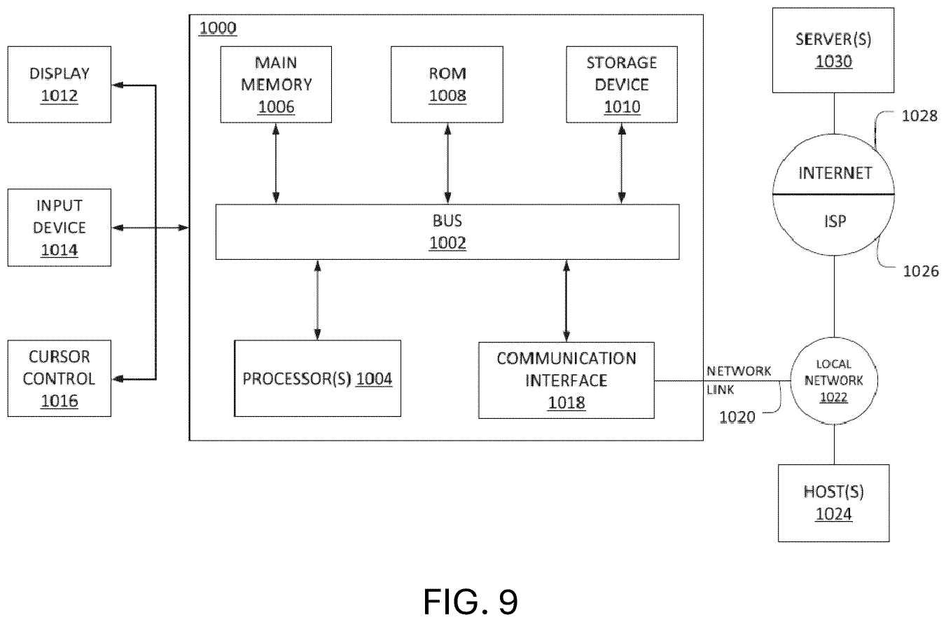

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

Organizations implement various methods of capturing a workflow, some of all of which is performed using a computer. In this context, “workflow” generally refers to a series of steps or activities for performing one or more tasks within that workflow and at least some of the steps or activities can be automated and/or supported with software tools for handling the one or more tasks in an efficient manner. Organizations may implement various methods of capturing workflows for further analysis of the workflow. Capturing workflows for further analysis can permit the organization, such as a business, to streamline processes to improve overall productivity. Capturing workflows creates a record of how a task is performed, which may improve knowledge sharing.

A software product, such as (but not limited to) a software application, of a consumer, may involve one or more workflows. The one or more workflows may involve use of one or more computational or computer-based models (hereafter “models”) for performing one or more tasks. For example, a generative workflow may involve use of one or more models for producing, for example, text, images, videos or other forms of data based on input data. Large language models (LLMs) are one example of generative models. However, the non-deterministic nature of generative models, such as, but not limited to, LLMs where the same input may produce different output at different times, may be problematic, for example when the output affects critical decision-making. LLMs have become increasing popular in recent times, owing to their ability to interpret and generate human-like text and other modalities such as images, video and audio. Existing LLMs have demonstrated impressive capabilities in various applications, including natural language processing, machine translation, text summarization and autonomous agent workflows. LLMs may potentially be used in other applications such as, but not limited to, computer and data security, encryption, image and audio processing and control of other computer systems. Most LLM architectures are autoregressive, meaning that they operate by taking a sequence of inputs, usually text, and predict a next token (unit of text), then reincorporate that prediction to the LLM to predict the next token, and so on until the task is completed. This, combined with finite training data, usually compiled from sources of the internet, can elicit emergent behaviours, like reasoning by reconstructing most-probable semantic sequences. However, when tasked with more nuanced context, LLMs can get things wrong and compound errors causing so-called hallucinations.

It is therefore appreciated that, where generative model outputs may affect critical decision-making, for example those related to, for example, healthcare applications, law enforcement, military, computer and data security, encryption, control of autonomous vehicles and so on, there is need to manage such workflows based on, for example, visibility of model's performance over time. Managing workflows may, for example, comprise monitoring model performance, providing transparency to consumer organizations in terms of at least summarizing model performance which may vary over time and may necessitate and/or facilitate replacing a current model configuration with a different model configuration. It is also desirable to improve audibility and interpretability of workflows such that consumer organizations may make justified decisions in terms of implementing models in their workflows. For example, it may be that a consumer organization be alerted as to decreased model performance for a critical task, which may involving pausing, taking offline and/or prompting a user to pause the workflow, so as to avoid adverse inputs to downstream issues and facilitate investigation and/or modification. This may further lead to processing and data storage efficiencies, because irrelevant data is no longer generated and/or stored, and in certain cases downstream actions are not performed erroneously such that they need to be undone and/or re-performed.

Example embodiments provide methods and systems which may improve transparency, auditability and interpretability of workflows, as well as potentially alerting and/or controlling at least part of the workflow to avoid problematic downstream actions.

Example embodiments relate to a development and operations (hereafter “DevOps”) tool or framework, tailored specifically for software products including AI workflows. The DevOps tool enables collaboration between a developer-side organization and an operations-side organization via respective user interfaces, although in some cases both developer and operations may be part of the same organization or even the same person. A developer is the developer of the software product, and the operations-side typically refers to an information technology team of a consumer organization which collaborates with the developer on an ongoing basis, so as to iteratively develop and/or improve the software product.

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

The term “model,” as used in the present disclosure, can include any computer-based models of any type and of any level of complexity, such as any type of sequential, functional, or concurrent model. Models are typically trained models. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

A “language model” can be any algorithm, rule, model, and/or other programmatic instructions that can receive natural language prompts and provide output based on data on which the AI model is trained, wherein the output can be a sequence of words, an image or other forms of output. For example, some language models predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. LLMs may work by taking an input text and, for example, repeatedly predicting the next word or token (e.g., a portion of a word, a combination of one or more words or portions of words, punctuation, and/or any combination of the foregoing and/or the like). An LLM may be of any type, including a Question Answer (“QA”) LLM that may be optimized for generating answers from a context, a multimodal LLM/model, and/or the like. An LLM (and/or other models of the present disclosure) may include, for example, a NN trained using self-supervised learning and/or semi-supervised learning, a feedforward NN, a recurrent NN, and/or the like. An LLM (and/or other models of the present disclosure) may further include, for example, attention-based and/or transformer architecture or functionality. LLMs can be extremely useful for natural language processing, including receiving natural language prompts and providing natural language responses based on the text on which the model is trained. LLMs may not be data security-or data permissions-aware, because they generally do not retain permissions information associated with the text upon which they are trained. Thus, responses provided by LLMs are typically not limited to any particular permissions-based portion of the model. LLMs may produce other modalities of output, including but not limited to images.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (Large Language Model Meta AI), and BigScience Large Open-science Open-access Multilingual Language Model (BLOOM).

A Model Configuration may refer to a combination of model and one or more hyperparameters, which are parameters that affect performance of the model. A change of model and/or one or more hyperparameters results in a different model configuration.

Data Processing Service (or “Service” or “Plug-in”): receives and responds to requests for data and/or data processing. A Plug-in may be accessible via an API that is exposed to an Artificial Intelligence System (and/or other remote systems) and allows data processing requests to be received via API calls from those systems (e.g., an AIS). A few examples of services or plug-ins include a table search service, a filter service, an object search service, a text search service, or any other appropriate search service, indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other data retrieval, processing, and/or analysis function.

Prompt (or “LLM Prompt” or “Natural Language Prompt” or “Model Input”): a term, phrase, question, and/or statement written in a human language (e.g., English, Chinese, Spanish, etc.) that serves as a starting point for a language model and/or other language processing. A prompt may include only a user input or may be generated based on a user input, such as by a prompt generation module (e.g., of an artificial intelligence system) that supplements a user input with instructions, examples, and/or information that may improve the effectiveness (e.g., accuracy and/or relevance) of an output from the language model. A prompt may be provided to an LLM, which the LLM can use to generate a response (or “model output”). Depending on the LLM, a prompt may be multi-modal, e.g., including data in non-text formats, such as images, audio, video, etc.

User Input (or “Natural Language Input”): a term, phrase, question, and/or statement written in a human language (e.g., English, Chinese, Spanish, etc.) that is provided by a user, such as via a keyboard, mouse, touchscreen, voice recognition, and/or other input device. User input can include a task to be performed, such as by an LLM, in whole or in part. User input can include a request for data, such as data accessed and/or processed by one or more services. User input can indicate one or more tools associated with the user request or task which may facilitate performing the task. User input can indicate one or more data object types associated with a tool. User input can indicate one or more actions associated with a tool. User input can include a user selection of a format for a response from an LLM. User input can include a user-defined variable to which a response may be saved.

Context: any information associated with user inputs, prompts, responses, etc. that are generated and/or communicated to/from the user, the artificial intelligence system, the LLM, the data processing services, and/or any other device or system. For example, context may include a conversation history of all of the user inputs, prompts, and responses of a user session. Context may be provided to an LLM to help an LLM understand the meaning of and/or to process a prompt, such as a specific piece of text within a prompt. Context can include information associated with a user, user session, or some other characteristic, which may be stored and/or managed by a context module. Context may include all or part of a conversation history from one or more sessions with the user (e.g., a sequence of user prompts and/or LLM prompts and orchestrator selector responses or results, and/or user selections (e.g., via a point and click interface or other graphical user interface). Thus, context may include one or more of: previous analyses performed by the user and/or LLM, previous prompts provided by the user and/or an artificial intelligence system, previous conversation of the user with the language model, schema of data being analyzed, a role of the user, a context of the data processing system (e.g., the field), and/or other contextual information.

A context module may provide all or only a relevant portion of context to a selection module for use in selecting one or more plug-ins and/or service orchestrators (e.g., configured to generate requests to plug-ins) for use in generating a properly formatted service request. Context can include tool information. Context can include tool implementation examples. In some embodiments, context may include identification of services and parameters of prior operations, but not underlying data that was accessed or retrieved by the service (e.g., use of graph visualization service and graph parameters without indicating the data illustrated in the graph). In some embodiments, context may include some or all of the underlying data accessed or retrieved by the service.

A Tool can include a set of logic or rules that can be provided to an LLM that the LLM can use to obtain additional information, such as by generating a request for access to additional data via a plug-in. Thus, a tool can be used by an LLM to generate requests (that may be fulfilled by the AIS) to perform operations such as querying datasets, processing data including filtering or aggregating data, writing to datasets (e.g., adding or updating rows of a table, editing or updating an object type, updating parameter values for an object instance, generating a new object instance), implementing integrated applications (e.g., an email or SMS application), communicating with external application programming interfaces (APIs), and/or any other functions that communicate with other external or internal components. Example tools include ontology function tool, date/time tool, query objects tool, calculator tool, and apply action tool. Tools, or the set of logic they comprise for performing one or more operations, may be defined by a system, external database, ontology, and/or a user. Some implementations may be agentic and others way be non-agentic. An agentic LLM implementation may be a framework where the LLM uses tools to affect its environment as well as perceive it, and functions/actions can be called without reliance on the LLM to invoke this (a form of LLM chain). A non-agentic LLM implementation may be a framework where human input and guidance is required.

Tool Information can include information associated with a tool that is provided to an LLM and is usable to implement the tool functionality. Tool information can indicate how data is structured, such as in an ontology. Tool information can indicate properties associated with a particular data object type, such as a data object type associated with a selected tool. Tool information can include instructions for implementing a tool. Tool information can include instructions for generating a tool call to use the tool, including instructions for formatting a tool call. In some implementations, tool information can comprise tool implementation examples for executing one or more tool operations which can include pre-defined examples, user-selected examples, user-generated examples, and/or examples that are automatically dynamically configured based on context.

Ontology: stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Object (or “Object”): a data container for information representing a specific thing in the world that has a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth.

An Object Type is a type of a data object (e.g., person, event, document, and/or the like). Object types may be defined by an ontology and may be modified or updated to include additional object types. An object definition (e.g., in an ontology) may include how the object is related to other objects, such as being a sub-object type of another object type (e.g., an agent may be a sub-object type of a person object type), and the properties the object type may have.

### Example System

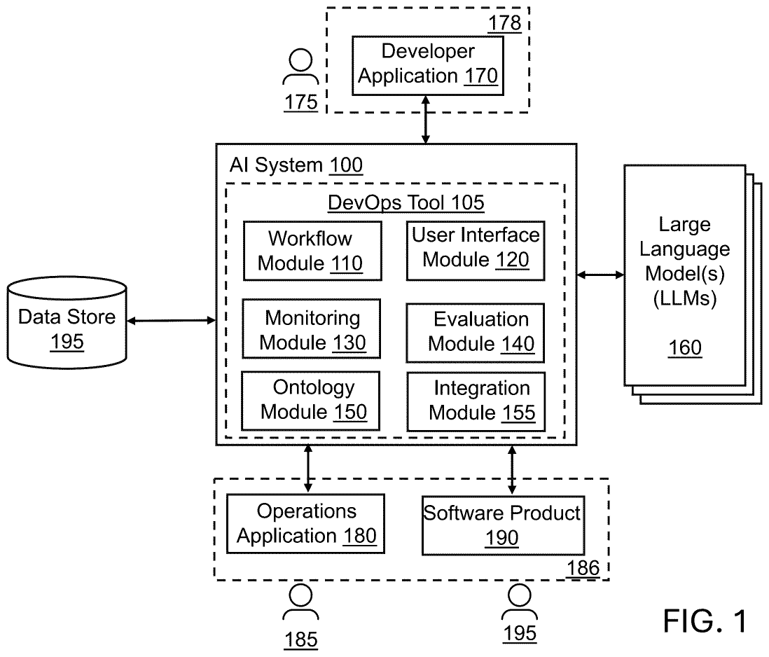

FIG. 1 illustrates an example system according to some example embodiments. The system is not to be considered limiting, and it will be appreciated that alternative systems and/or architectures arranged and/or aimed at the same or similar purpose as that described herein may be applicable. The system may comprise an artificial intelligence (AI) system 100 which may comprise a platform, framework, tool or application facilitating at least management, monitoring and maintenance of workflows for a software product. The AI system 100 may be a cloud-based system that can be accessed and, in some cases, edited and controlled by one or more other systems and/or users.

For example, the AI system 100 may provide a DevOps platform, framework or tool (hereafter “DevOps tool”) 105 comprising a workflow module 110, a user interface module 120, a monitoring module 130, an evaluation module 140, an ontology module 150 and an integration module 155. The term “module” refers to a functional module that may be implemented in software, hardware, a combination of software and hardware, or similar.

The system may also comprise, or have access to, one or more LLMs 160 which can be selectively used by the AI system 100 as part of a workflow of a software product 190 that is managed by the AI system via the DevOps tool. The LLMs 160 may be provided by one or more platforms external (or alternatively internal) to the AI system 100, accessed via any form of data network, and may be for any suitable purpose, examples of which are given above.

A developer application 170 may be an application, platform or user interface system associated with, or usable by, a developer 175 of a software product 190. The developer application 170 may be associated with a first system, which may be a developer system 178. The developer application 170 may alternatively comprise a part of the AI system 100 or DevOps tool 105.

An operations application 180 may be an application, platform or user interface system associated with, or usable by, an operations user 185 (or operations team) associated with a consumer-side system 186. The operations application 180 may alternatively comprise a part of the AI system 100 or DevOps tool 105.

The software product 190 may comprise an application, platform or user interface system associated with, or usable by, one or more consumer-side users 195, for example end-users. In some examples, the software product 190 may be hosted by the AI system 100, or elsewhere in the cloud, for remote access by the one or more end-users of a software product to which they have access.

A data store 195, in signal communication with the AI system 100 may store data sets comprising one or more data items associated with current and historical use of the software product 190 (wherever hosted). The data items may include, or represent, context data which, for example, may reflect application, by a particular user, of a particular LLM 160 as part of a workflow, as well as related data, e.g., metadata, indicative of one or more of model configurations, outputs, evaluations, user feedback, token usage, average latency and so on. The data store 195 may store data sets in accordance with an ontological model (an object model or graph) indicative of logged parameters and their relationships.

The DevOps tool 105 may comprise a workflow module 110 for obtaining a workflow of an application, for example the software product 190. The workflow may be obtained by user input via, for example, the developer application 170 operating a workflow creation tool of the workflow module 110 which enables defining of the workflow broken down into distinct elements including one or more tasks of the software product 190. The workflow, its constituent elements and parameters may be represented by workflow data. A task in this context is a part of a workflow that uses one or more models, for example one of the LLMs 160, to perform the task.

In some examples, the software product 190 may be developed and built in this manner using the DevOps tool 105, that is by the developer 175 defining the workflow using the workflow module 110 and deploying or activating the software product 190 using the integration module 155 for use at, or by, the consumer-side system 186.

Furthermore, as will be explained below, the developer 175 may monitor and update (change) parts of the workflow via the workflow module 110 and the integration module 155 may responsively integrate updates to the software product 190, for example changes to the workflow and/or model configurations through continuous integration (CI) and/or in batches using existing extract, transform and load (ETL) processes.

The DevOps tool 105 may also comprise a user interface module 120 for providing display data, including first display data to at least the developer application 170, and second display data to at least the operations application 180. The first display data and the second display data may provide and/or update, respective first and second user interfaces which may comprise interactive user interfaces. In this respect, the first user interface may comprise a developer user interface or dashboard accessible through the developer application 170, and the second user interface may comprise an operations user interface, console or dashboard accessible through the operations application 180.

The DevOps tool 105 may also comprise a monitoring module 130 providing monitoring of certain parameters associated with the workflow, which parameters may be visualized via the developer user interface and/or operations interface and stored or logged to the data store.

The DevOps tool 105 may also comprise an evaluation module 140 providing evaluation functionality; this may involve use of one or more known “evaluators” which use various algorithms to indicate performance of models. LLM evaluators are, for example, known and accessible from various sources and generally may operate by comparing inference output with expected output to provide one or more evaluation results, which may be in respect of metrics such as prompt drift, correctness of output, conciseness of output, readability of output, semantic equality of output or output structure adherence. Evaluation results may be expressed in terms of a pass/fail result based on a benchmark or threshold, a numerical score or percentage, to give some examples.

The DevOps tool 105 may also comprise an ontology module 150 for ontologizing data associated with particular users, for example that of the consumer side system 186, such that data associated with the software product 190 (or indeed all of its software products) is logged and therefore stored in the data store 195 in accordance with an ontology (object model) therefore providing a complete, accurate and easily accessible way of retrieving and organizing data of the consumer side system 186. The ontology module 150 may provide version controls and access or privacy controls, ensuring that users of particular organizations can only access data sets of their respective organization and not those of other organizations. The ontology module 150 retains lineage information of operations, such as who performed what and when, enabling subsequent auditing of the decision-making processes.

By way of example, the software product 190 may a software product that implements or is implementing the workflow defined or otherwise obtained by workflow data of the workflow module 110, wherein the workflow comprises series of tasks involving use of one or more models. The software product 190 may, for example, include a task of summarizing a first set of data or information into a second set of data, wherein the second set of data should meet certain requirements, for example in terms of conciseness, readability, correctness and/or output format. At least one LLM 160 may be used for this purpose, wherein the LLM may receive as input a text prompt requesting performance of the task, such as “provide me with a summary of hospital discharge notes for patients discharged within the past 24 hours, and with the output in the following format . . . ” The LLM 160 may, based on such a prompt, access or cause access to other datastores or systems to access structured or unstructured data that may be used as part of the task; this may involve passing accessed data to other parts of the workflow for transformation and/or other processing, and the LLM 160 may provide as output a summary which may (or may not) meet required criteria.

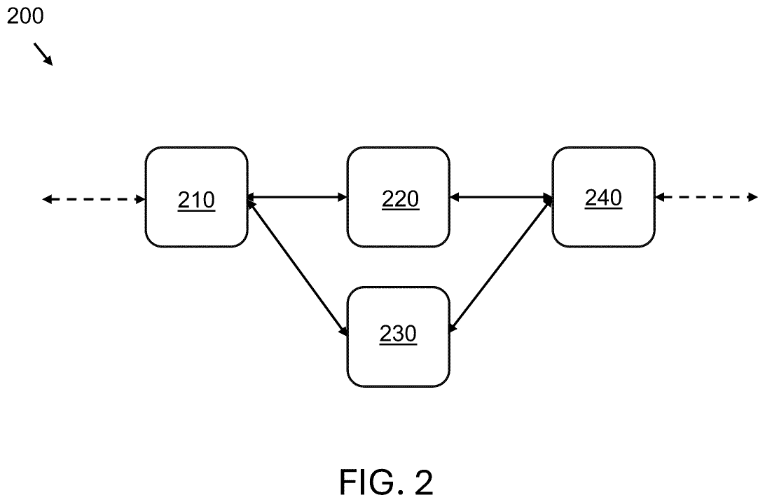

FIG. 2 illustrates at least part of a workflow 200 which may be useful for understanding example embodiments. The workflow 200 may comprise a plurality of elements, in this case first to fourth elements 210, 220, 230 240 which may represent any of data, tasks, ontology objects, transforms and so on. In this example, the first element 210 receives input data and provides a set of output data to the second and third elements 220, 230. The second and third elements 220, 230 provide respective sets of output data to the fourth element 240. The workflow 200 may be defined using the workflow module 110 to provide workflow data. In the case that at least one of the first to fourth elements, say the second element 220, represents a task, the workflow module 110 may enable the developer 175, by means of the developer user interface of the DevOps tool 105, to define and/or modify the task and associated parameters.

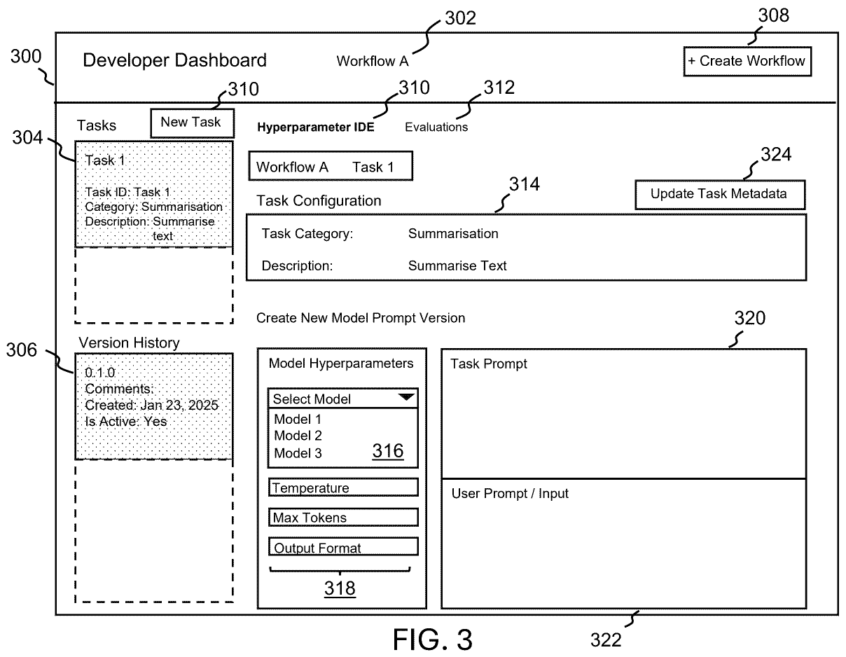

FIG. 3 illustrates an example developer user interface (hereafter “developer dashboard”) 300 of the DevOps tool 105 which may be accessed, viewed and interacted with by a user, for example the developer 175.

The developer dashboard 300 indicates a first page indicative of information relating to a workflow (workflow A) of the software product 190, as indicated by user interface element 302. One or more tasks of the workflow may be indicated by user interface element 304, wherein one task (task 1) is selected and therefore highlighted. One or more versions of the selected task (task 1) may be indicated by user interface element 306, wherein one version (version 0.1.0) is selected and therefore highlighted. In some examples, a plurality of selectable tasks and/or versions may be indicated. Associated with each of the highlighted task and version may be provided metadata such as user-provided comments, a creation date and an indication of whether the version is active, that is operational in the software product 190 or not.

The developer dashboard 300 also enables creation of new workflows via a user interface element 308, and creation of new tasks via a user interface element 310.

The developer dashboard 300 provides various other information based on the selection of a current workflow, task and version, at least some of which may be interacted with to configure one or more features of the task and evaluations to be applied to the task as part of the DevOps tool 105 and by the evaluation module 140. For example, the developer 175 may toggle between hyperparameter and evaluations views via user interface elements 310 and 312. For the hyperparameter view, as shown, the developer 175 may view and, if required edit, task category and description information via user interface element 314. The task category may be selected from a plurality of selectable options, such as summarisation. The developer 175 may also set, or update, model configurations, a model configuration comprising a model and one or more hyperparameters of the model. The developer 175 may identify, or select, which model (or model version) is to be used for the task via a user interface element 316, which may comprise selection from a list via a drop-down menu or similar, for example one of Model 1, Model 2 or Model 3 (examples of known models are described above). The developer 175 may also set, or update, one or a set of hyperparameters to be applied to the selected model, including, but not limited to, temperature, maximum number of tokens, output format and/or other inference hyperparameters, via interaction with user interface element(s) 318. The developer 175 may also set, or update, a task prompt via text entry field 320. The developer 175 may also set, or update, a user prompt/input via text entry field 322.

Selection of an “update task metadata” user interface element 324 updates the current task and version history.

Having configured, or updated, the task configuration, the developer 175 may select a set of one or more evaluator programs (“evaluators”) for enabling the evaluation module 140 to evaluate, at a plurality of time instances, performance of the task using the selected model based on the selected hyperparameter(s). The evaluators may provide respective evaluation results as indicated above. The one or more evaluators may evaluate performance of the task based on the category associated with the task, such as summarisation. In some examples, the category may automatically determine which evaluators are selected. Example evaluators may evaluate prompt drift, correctness of output, conciseness of output, readability of output, semantic equality of output and/or output structure adherence. Evaluation results may be expressed in terms of a pass/fail result based on a benchmark or threshold, a numerical score or percentage, to give some examples. The evaluators may operate on test data of the DevOps tool.

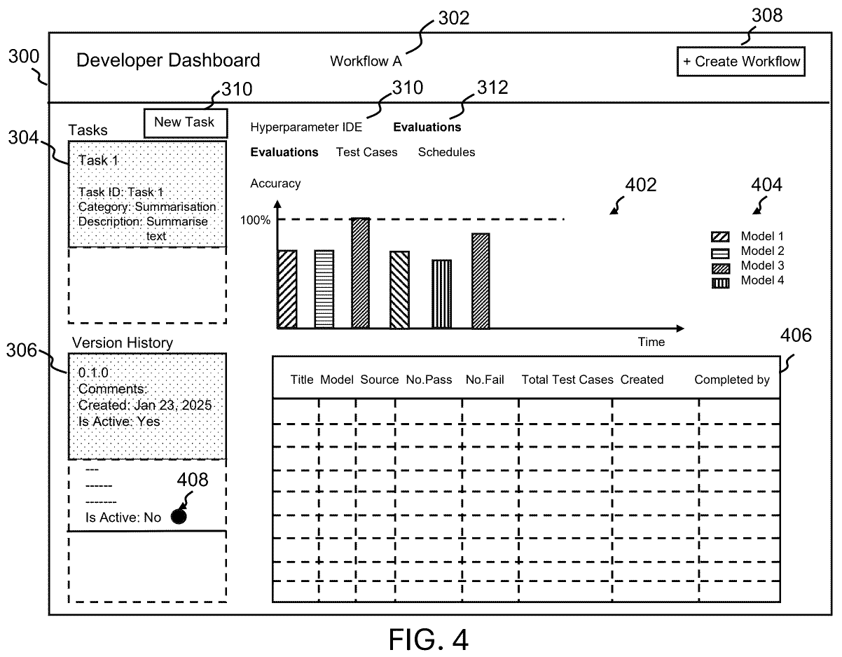

Referring now to FIG. 4, selection of the evaluations view (via user interface element 312) may provide a view of evaluation results. Within the evaluations view, the developer 175 can view evaluation results in graphical and/or tabular form. For example, a first graph 402 illustrates evaluation results for correctness of output (accuracy) with respect to a timeline during which a current model configuration (comprising a particular combination of model and one or more hyperparameters) may have been modified. A legend 404 may indicate which models were used to perform the task and when. For example, a first table 406 may additionally, or alternatively, indicate a list of test runs, including parameters of title, model, source (manual or automatic), number of passes, number of passes, number of failures, total test cases, creator/creation data of the test run and date and/or time completed. User selection of any entry within the first graph 402 and/or the first table 406 may enable the user to drill-down and view additional information associated with the test run from a logged data set associated with the task.

The evaluations view therefore enables the developer 175, to configure and evaluate performance of particular task configurations, not only to provide visibility as to ongoing performance of such task configurations but also to enable end-users, for example the operations user 185, to access the evaluations (or at least a summarised version thereof) via their operations-side user interface such that they have confidence that a currently-active model configuration (or a potentially new model configuration) is sufficiently performant for the particular task.

Further, the developer dashboard 300, by virtue of its hyperparameter and evaluations views, enables the developer 175 to evaluate and generate evaluation data prior to a particular model being deployed or activated in the software product 190 as part of the workflow. For example, the product developer 175 may produce a test run for a new version of a model, or a completely different model, without it being activated in the software product 190. The product developer 175 may also modify one or more of the hyperparameters, whether temperature, maximum number of tokens, output format, task prompt and/or user prompt, to ascertain changes in performance prior to deployment or activation in the software product 190. Activation may be performed, for example by selecting a button 408 associated with an “inactive” task version to make an inactive version active.

Furthermore, the developer dashboard 300 may display feedback data received from operations users 185 and/or end-users 195 of the software product 190. As will be explained below, the operations user 185 may, via the operations user interface, associate at least one feedback template with a task such that it becomes integrated with the software product. In this way, when an end-user 195 is operating the software product 190, they may be presented with the option to input feedback data as part of the software product 190. A feedback template may comprise a form requesting specific feedback data to a prompt, such as “is the output as expected?” with options of yes/no, a rating of 0-10, a percentage score and/or textual feedback. The developer 175 may, upon receiving feedback data, for example negative feedback data, investigate causes and, if required, modify a current model configuration, re-perform evaluations and, if appropriate, activate the modified model configuration in the software product 190. Alternatively, the DevOps tool 105 in some examples, may process the feedback data using an LLM model and, if appropriate, prompt the developer to investigate the cause and/or automatically pause activation of the current model configuration and/or replace the current model configuration with a modified model configuration evaluated as more performant based on already-run evaluations.

Furthermore, the developer dashboard 300 may display other data, including monitoring data, that may be displayed as part of the operations user interface to be described below.

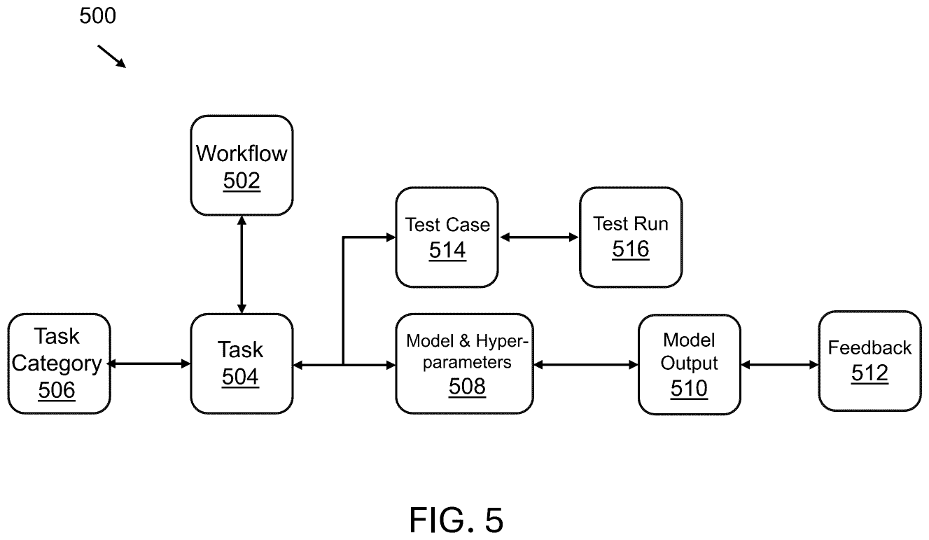

The DevOps tool 105 may furthermore log datasets based on the above operations and evaluations in accordance with an object-based (object-relational) model referred to herein as an ontology. Datasets generated through use of the DevOps tool 105 may be represented as objects with associated versions and version controls. FIG. 5 illustrates an example ontology 500 comprising objects and nodes (or edges) indicating relationships between the objects. For example, a first to eighth object 502, 504, 506, 508, 510, 512, 514, 516 may comprise a workflow object, a task object, a task category, model and hyperparameter(s), model output, feedback, test cases and test runs, respectively. Therefore, for a particular workflow object 502, there may a related task object 504, and the task object may be related to one or more task category objects 506, for example, summarisation or unstructured data extraction. The task object 504 may also be related to the model and hyperparameter object 508 and the test case object 514. The model and hyperparameter object 508 may be related to the model output object 510 which is in turn related to the feedback object 512. The test case object 514 is related to the test run object 516.

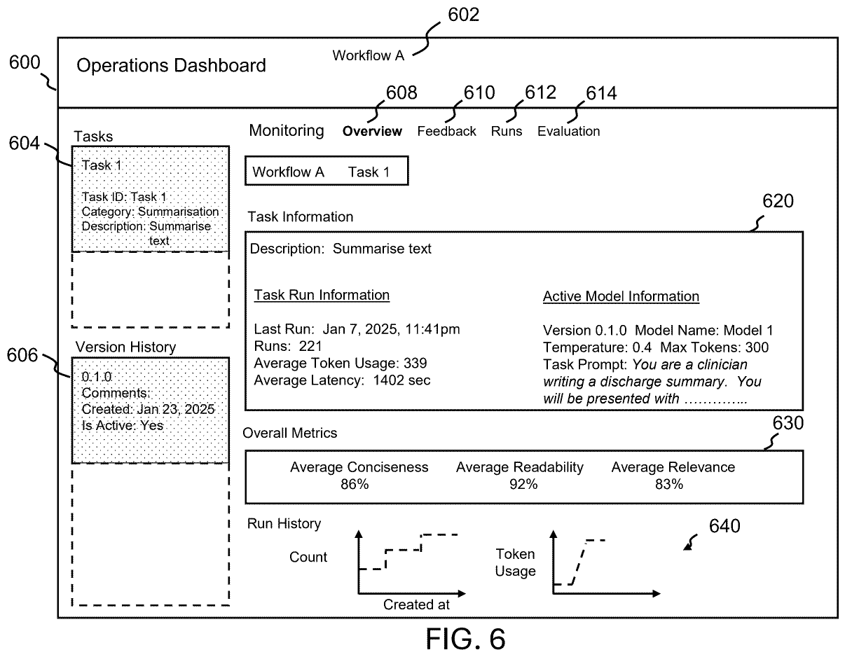

FIG. 6 illustrates an example operations user interface (hereafter “operations dashboard”) 600 of the DevOps tool 105 which may be accessed, viewed and interacted with by a user, for example the operations user 185.

The operations dashboard 600 indicates a first page indicative of information relating to the workflow (workflow A) of the software product 190, as indicated by user interface element 602. One or more tasks of the workflow may be indicated by user interface element 604, wherein one task (task 1) is selected and therefore highlighted. One or more versions of the selected task (task 1) may be indicated by user interface element 606, wherein one version (version 0.1.0) is selected and therefore highlighted. In some examples, a plurality of selectable tasks and/or versions may be indicated. Associated with each of the highlighted task and version may be provided metadata such as user-provided comments, a creation date and an indication of whether the version is active, that is operational in the software product 190 or not.

The operations dashboard 600 provides various other information based on the selection of a current workflow, task and version, at least some of which may be interacted with. For example, the operations user 185 may toggle between overview, feedback, runs and evaluations pages via respective user interface elements 608, 610, 612, 614.

FIG. 6 illustrates the overview page which indicates a summary of performance parameters for a currently-activated model configuration for the task. For example, a window 620 indicates task run information, including at least one of time of a most-recent run, total number of runs, average token usage for total number of runs, or average latency for total number of runs. For example, the window 620 also indicates active model information indicative of the currently-activated model configuration, including details of the model used, version, and hyperparameters. For example, a window 630 indicates overall metrics, being a summary of performance values determined by evaluators configured via the developer dashboard 300, including in this example values of average conciseness, average readability and average relevance as percentages. For example a window 640 indicates graphs representing count and token usage with respect to time.

Selection of user interface element 610 may toggle the operations dashboard 600 to a feedback page, via which the operations user 185 may view existing feedback data and enter their own feedback data relating to performance of a current model configuration.

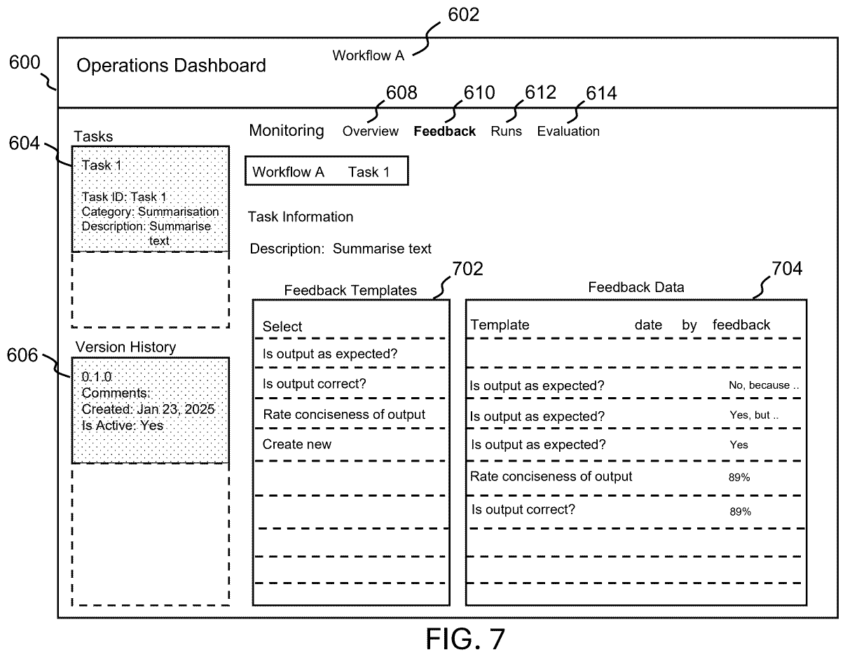

FIG. 7 illustrates an example feedback page, which includes a feedback templates portion 702 and a feedback data portion 704. The feedback templates portion 702 may indicate one or more selectable feedback templates for receiving respective types of feedback data as shown. An option to create a new feedback template may also be provided.

The operations user 185 may associate, via the operations dashboard 600 (for example via a double-click or drag-and-drop association) one or more feedback templates with the task highlighted in user interface portion 604 or 606. This may cause the one or more feedback templates to become integrated with the software product 190. In this way, when an end-user 195 is operating the software product 190, they may be presented with the option to input feedback data as part of the software product 190 operation.

The feedback templates may comprise a form requesting specific feedback data to a prompt, such as “is the output as expected?” with options of yes/no, a rating of 0-10, a percentage score and/or free text feedback.

The feedback data portion 704 indicates a list of received feedback data for the task highlighted in user interface portion 604 or 606. The operations user 185 may select any of such list to view further details. The operations user 185 may also, upon receiving the feedback data, flag potential issues to the developer 175 by sharing the feedback data to the developer dashboard 300. Alternatively, or additionally, the feedback data may always be accessible to the developer 175 via the developer dashboard 300.

The developer 175 may, upon receiving feedback data, for example negative feedback data, investigate causes and, if required, modify a current model configuration, re-perform evaluations and, if appropriate, activate the modified model configuration in the software product 190. Alternatively, the DevOps tool 105 in some examples, may process the feedback data using an LLM model and, if appropriate, prompt the developer to investigate the cause and/or automatically pause activation of the current model configuration and/or replace the current model configuration with a modified model configuration evaluated as more performant based on already-run evaluations.

Selection of user interface element 612 may toggle the operations dashboard 600 to a runs page, via which the operations user 185 may view past runs of model configurations for the task, and drill-down to view associated metadata.

Selection of user interface element 614 toggle the operations dashboard 600 to an evaluation page, via which the operations user 185 may view at least a summary of the evaluations performed at the developer-side, for example average performance values, most recent performance values, or possible the same performance values that can be accessed via the developer user interface 300.

In overall summary, the DevOps tool 105 provides functionality that may improve collaboration between developers and operations-side users, providing for example transparency as to which model configurations are associated with one or more tasks of a workflow, including associated performance characteristics, as well as auditability and interpretability. The DevOps tool 105 enables continuous monitoring and evaluation of models with respect to various tasks to promote confidence in AI product users as well as informing developers that changes do not cause regression. The DevOps tool 105 may, by the sharing of data via user interfaces, provide ongoing assurances that tasks or tasks are working as intended, provide visibility as to regressions of models and/or hyperparameters, for example during events such as product upgrades, or when a model provider upgrades their model which may result in prompt and/or behaviour drift. The DevOps tool 105 may further enable modifying/switching of model configurations via the workflow and integration modules 110, 155 (facilitated by the modularity and portability of data objects by the ontology module 150) in a plug-and-play manner with the ability to test performance and/or output, compare with current and/or earlier versions, prior to integration in the software product. In some examples, the DevOps tool 105 may, based on detecting a performance decrease in one or more activated model configurations, automatically pause and/or prompt user intervention to replace the activated model configuration with a different model configuration that is determined based on test runs to be more performant.

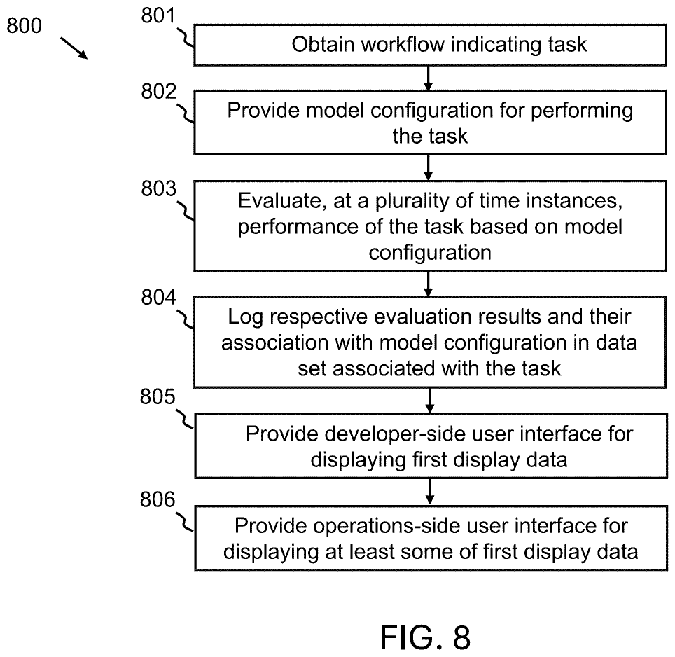

FIG. 8 is a flow diagram showing operations 800 that may be performed in accordance with some example embodiments. The operations may be performed by hardware, software, firmware or a combination thereof. The operations may be performed by one, or respective, means, a means being any suitable means such as one or more processors or controllers in combination with computer-readable instructions provided on one or more memories.

A first operation 801 may comprise obtaining workflow data indicating a task. The workflow data may represent a workflow of a software product, for example an AI software product, wherein the task is performed based on at least one model such as a generative model, e.g. LLM. The workflow data may be received via a workflow generation tool.

A second operation 802 may comprise providing at least a first model configuration for performing the task. The providing may comprise receiving, detecting or identifying.

A third operation 803 may comprise evaluating, at a plurality of time instances, performance of the task based on the at least first model configuration. The third operation 803 may provide respective evaluation results.

A fourth operation 804 may comprise logging the respective evaluation results and their association with the at least first model configuration in a data set associated with the task.

A fifth operation 805 may comprise providing, based at least in part on the data set, at least a developer-side user interface for displaying at least first display data. The developer-side user interface may, for example, indicate the task, at least some evaluation results and their association with the at least first model configuration.

A sixth operation 806 may comprise providing, based at least in part on the data set, an operations-side user interface for displaying at least second output data. The operations side user interface may indicate at least some of the first display data. The operations-side user interface may be accessible by at least one user of the software product, such as an operations user.

The order of operations is not necessarily indicative of order of processing. For example, the fifth and sixth operations 805, 806 may be performed in any order or at the same time.

In some examples, the developer-side user interface may provide additional functionality to the operations-sider user interface. For example, the developer-side user interface enables modifications to model configurations and their activation or deployment to the software product, whereas the operations-side user interface does not.

In some examples, the evaluations may be performed in response to user input and/or automatically according to a configured schedule (e.g. a regular cadence). In some examples, the evaluations may be performed automatically in response to a negative user feedback and/or in response to an update to a current model configuration.

In some examples, another operation comprises receiving feedback data indicative of operational performance of the at least one task using the at least first model configuration, wherein the feedback data is stored in the data set in association with the at least first model configuration for the task and is accessible via the developer-side user interface and the operations-side user interface. In some examples, another operation comprises enabling, via input to the operations-side user interface, association of at least one feedback template with the at least one task of the software product, wherein the association integrates the at least one feedback template as part of the software product and the feedback data is received via the at least one feedback template. The at least one feedback template may provide at least one form for requesting feedback data from a user of the software product.

In some examples, another operation may comprise modifying at least part of the at least first model configuration to provide at least a second model configuration and re-performing the evaluating.

In some examples, the modifying is performed based, at least in part, on the feedback data.

In some examples, the evaluating comprises evaluating, at one or more first time instances, performance of the at least one task using the at least first model configuration and, at one or more second time instances, performance of the at least one task using at least the second model configuration, wherein the respective evaluation results are displayed to the developer-side user interface with respect to a timeline. In some examples, the at least second model configuration comprises at least one of a different version of the first model or a different model to the first model. In some examples, the second model is selected, via the developer-side user interface, from a list of selectable models for replacing the first model. In some examples, the at least second model configuration comprises at least one modified hyperparameter or set of hyperparameters. In some examples, the at least one modified hyperparameter or set of hyperparameters is or are received via the developer-side user interface. In some examples, the at least one modified hyperparameter or set of hyperparameters comprises at least one of a prompt, a temperature, or other inference hyperparameter.

In some examples, the evaluating comprises running, at each of the plurality of time instances, at least one evaluator program to evaluate performance of the at least one task with respect to a, or a respective, metric. In some examples, the at least one evaluator program is selected based on a category assigned to the at least one task via the developer-side user interface. In some examples, the at least one evaluator program evaluates performance with respect to at least one of: prompt drift, correctness of output, conciseness of output, readability of output, semantic equality of output or output structure adherence.

In some examples, the at least first model configuration is activated in the software product for performing the at least one task. Other operations may comprise receiving monitoring data indicative of a consecutive runs of the at least first model configuration; logging the monitoring data in the data set in association with the at least first model configuration; and outputting, to at least the developer-side user interface, and possibly also to the operations-sider user interface, an indication of at least some of the monitoring data. In some examples, the monitoring data includes at least one of time of a most-recent run, total number of runs, average token usage for total number of runs, or average latency for total number of runs.

In some examples, another operation comprises receiving, via the developer-side user interface, an activation input for activating a non-activated model configuration in the software product; and activating the non-activated model in the software product.

In some examples, the data set comprises a version-controlled object model associated with the workflow of the software product.

In some examples, the at least first model is a large language model (LLM).

### Additional Example Implementations and Details

In an implementation, the systems or devices described herein may comprise, or be implemented in, a “virtual computing environment”. As used herein, the term “virtual computing environment” should be construed broadly to include, for example, computer-readable program instructions executed by one or more processors to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 8 shows a block diagram that illustrates a computer system 1000 upon which various implementations and/or aspects (e.g., one or more aspects of the DevOps tool 105 may be implemented. Multiple such computer systems 1000 may be used in various implementations of the present disclosure. Computer system 1000 includes a bus 1002 or other communication mechanism for communicating information, and a hardware processor, or multiple processors, 1004 coupled with bus 1002 for processing information. Hardware processor(s) 1004 may be, for example, one or more general purpose microprocessors.

Computer system 1000 also includes a main memory 1006, such as a random-access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. The main memory 1006 may, for example, include instructions to implement server instances, queuing modules, memory queues, storage queues, user interfaces, and/or other aspects of functionality of the present disclosure, according to various implementations.

Computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), and/or the like, is provided and coupled to bus 1002 for storing information and instructions.

Computer system 1000 may be coupled via bus 1002 to a display 1012, such as a cathode ray tube (CRT) or LCD display (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computing system 1000 may include a user interface module to implement a GUI that may be stored in a mass storage device as computer executable program instructions that are executed by the computing device(s). Computer system 1000 may further, as described below, implement the techniques described herein using customized hard-wired logic, one or more ASICs or FPGAs, firmware, and/or program logic which in combination with the computer system causes or programs computer system 1000 to be a special-purpose machine. According to one implementation, the techniques herein are performed by computer system 1000 in response to processor(s) 1004 executing one or more sequences of one or more computer-readable program instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicate with a WAN). Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds at which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure according to some embodiments. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description according to some embodiments. All changes which come within the meaning and range of equivalency of the claims are to be embraced within their scope.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method, wherein the method is performed using one or more processors, the method comprising:
obtaining workflow data representing a workflow of a software product, the workflow data indicating at least one task of the software product;
providing at least a first model configuration indicating at least a first model for performing the at least one task based on at least one hyperparameter or set of hyperparameters;
evaluating, at each of a plurality of time instances, performance of the at least one task using the at least first model configuration to provide respective evaluation results;
logging the respective evaluation results and their association with the at least first model configuration in a data set associated with the at least one task; and
providing, based on the data set, at least:
a developer-side user interface for displaying at least first display data indicating the at least one task, at least some of the respective evaluation results and their association with the at least first model configuration, and
an operations-side user interface for displaying at least second output data indicating at least some of the first display data, wherein the operations-side user interface is accessible by at least one user of the software product.

2. The computer-implemented method of claim 1, further comprising:
receiving feedback data indicative of operational performance of the at least one task of the software product using the at least first model configuration, wherein the feedback data is stored in the data set in association with the at least first model configuration for the task and is accessible via the developer-side user interface and the operations-side user interface.

3. The computer-implemented method of claim 2, further comprising:
enabling, via input to the operations-side user interface, association of at least feedback template with the at least one task of the software product, wherein the association integrates the at least one feedback template as part of the software product and the feedback data is received via the at least one feedback template.

4. The computer-implemented method of claim 3, wherein the at least one feedback template provides at least one form for requesting feedback data from a user of the software product.

5. The computer-implemented method of claim 4, further comprising modifying at least part of the at least first model configuration to provide at least a second model configuration and re-performing the evaluating.

6. The computer-implemented method of claims 5, wherein the modifying is performed based, at least in part, on the feedback data.

7. The computer-implemented method of claim 5, wherein the evaluating comprises evaluating, at one or more first time instances, performance of the at least one task using the at least first model configuration and, at one or more second time instances, performance of the at least one task using at least the second model configuration, wherein the respective evaluation results are displayed to the developer-side user interface with respect to a timeline.

8. The computer-implemented method of claim 7, wherein the at least second model configuration comprises at least one of a different version of the first model or a different model to the first model.

9. The computer-implemented method of claim 7, wherein the second model is selected, via the developer-side user interface, from a list of selectable models for replacing the first model.

10. The computer-implemented method of claim 7, wherein the at least second model configuration comprises at least one modified hyperparameter or set of hyperparameters.

11. The computer-implemented method of claim 10, wherein the at least one modified hyperparameter or set of hyperparameters is or are received via the developer-side user interface.

12. The computer-implemented method of claim 10, wherein the at least one modified hyperparameter or set of hyperparameters comprises at least one of a prompt, a temperature, or other inference hyperparameter.

13. The computer-implemented method of claim 1, wherein the evaluating comprises running, at each of the plurality of time instances, at least one evaluator program to evaluate performance of the at least one task with respect to a, or a respective, metric.

14. The computer-implemented method of claim 13, wherein the at least one evaluator program is selected based on a category assigned to the at least one task via the developer-side user interface.

15. The computer-implemented method of claim 13, wherein the at least one evaluator program evaluates performance with respect to at least one of: prompt drift, correctness of output, conciseness of output, readability of output, semantic equality of output or output structure adherence.

16. The computer-implemented method of claim 1, wherein the at least first model configuration is activated in the software product for performing the at least one task, the method further comprising:
receiving monitoring data indicative of a consecutive run of the at least first model configuration;
logging the monitoring data in the data set in association with the at least first model configuration; and
outputting, to at least the developer-side user interface, an indication of at least some of the monitoring data.

17. The computer-implemented method of claim 16, wherein the monitoring data includes at least one of time of a most-recent run, total number of runs, average token usage for total number of runs, or average latency for total number of runs.

18. The computer-implemented method of claim 1, further comprising:
receiving, via the developer-side user interface, an activation input for activating a non-activated model configuration in the software product; and
activating the non-activated model in the software product.

19. The computer-implemented method of claim 1, wherein the data set comprises a version-controlled object model associated with the workflow of the software product.

20. The computer-implemented method of claim 1, wherein the at least first model is a large language model (LLM).

21. A system, comprising:
at least one processor; and
at least one memory storing instructions that, when executed by the at least one processor, cause the system to perform the operations comprising:
obtaining workflow data representing a workflow of a software product, the workflow data indicating at least one task of the software product;
providing at least a first model configuration indicating at least a first model for performing the at least one task based on at least one hyperparameter or set of hyperparameters;
evaluating, at each of a plurality of time instances, performance of the at least one task using the at least first model configuration to provide respective evaluation results;
logging the respective evaluation results and their association with the at least first model configuration in a data set associated with the at least one task; and
providing, based on the data set, at least:
a developer-side user interface for displaying at least first display data indicating the at least one task, at least some of the respective evaluation results and their association with the at least first model configuration, and
an operations-side user interface for displaying at least second output data indicating at least some of the first display data, wherein the operations-side user interface is accessible by at least one user of the software product.
